(19) United States
(12) Patent Application Publication
(10) Pub. No.: US 2018/0106423 A1
(43) Pub. Date: Apr. 19, 2018

(54) Multi-Angle Magnetic Holder

(71) Applicant: Harry Wong, South Pasadena, CA (US)

(72) Inventor: Harry Wong, South Pasadena, CA (US)

(21) Appl. No.: 15/297,977

(22) Filed: Oct. 19, 2016

(51) Int. Cl. F16M 13/02; F16B 1/00; F16M 11/20; B25B 11/00

(52) U.S. Cl. CPC F16M 13/022; F16B 1/00; F16B 2001/0035; B25B 11/002; F16M 11/2007

(57) ABSTRACT

Present invention provides for magnetic clamping tools where desired angles can be selectively set by adjusting a tightening mechanism in a locking hinge connecting two arm pieces, as well as some preset angles of 30-degree, 45-degree and 90-degree; each of the arm piece is disposed between two opposite covers that are made of magnetizable materials, serving to provide the contact angle to the work pieces being held/worked on.

### FIELD AND BACKGROUND OF THE INVENTION

Present invention disclosed and claimed a magnetic holding device for holding metal and magnetizable work pieces. More specifically, the magnetic holding device disclosed in present application provides an easy angle settling feature, including some common preset angles, that are easy and convenient for day to day usage, making this a versatile tool that greatly enhances productivity.

### SUMMARY OF THE INVENTION

The invention relates to magnetic holding tools that can be used on iron, metal and other magnetizable objects. The holding tools have two arm pieces that, depending on users' setting, easily form an angle as desired, by using an Allen key to quickly set the angle.

Fixed angle version is provided for 90-degree inside; and 30-degree, 60-degree and 90-degree outside clamping applications are made easy as well.

Variable angle version allows for any angle clamping, from 30-degree to 180-degree. Some quick angle setting features are available for 30-degree (no pin), 45-degree (pin inserted in a 45D hole) and 90-degree (pin in a notch).

A hex hole is made on an arm piece, allowing the use of an Allen key, or other similar hard object, to pry the magnetic holding tool away from the work piece.

A locking hinge, with a six-sided Allen key hole, provides for a simple tightening mechanism to use an Allen key to set/adjust the desired angle formed by pivoting the two arm pieces.

### DESCRIPTION OF THE DRAWINGS

The accompanying drawings, which are incorporated in and constitute a part of this specification, illustrate and exemplify the preferred embodiments of the invention. Together with the description, serve to explain the principles of the invention.

A brief description of the drawings is as follows:

FIG. 1 shows a fixed angle version of a magnetic holder, with some outside bevel angles preset to 30, 45, or 60 degrees as selected and made by manufacturers.

FIG. 2 shows a variable angle magnetic holder, with a round pin adjacent to the holder indicated by a dotted line noting the place of insertion into a 45D hole in the second arm piece.

FIG. 3 shows the variable angle magnetic holder, with the two arm pieces maintaining a 30-degree angle where the protruding nut rests on an edge of the first arm piece.

FIG. 4 shows the variable angle magnetic holder, with the two arm pieces maintaining a 45-degree angle where the round pin is inserted into the 45D hole and the tips of the round pin are wedged into the cave-in notch of the first arm piece.

FIG. 5 shows the variable angle magnetic holder, with the two arm pieces maintaining a 90-degree angle where the round pin are placed into the cave-in notch, creating a contact point on the second arm piece and opening a 90-degree angle between the two arm pieces.

FIG. 6 shows a sample usage by the magnetic holders disclosed in this application. A round cover plate is clamped to a cylindrical tank using three fixed angle version magnetic holders, and the tank is clamped to the base plate using three fixed angle holders (one is behind the tank and not shown).

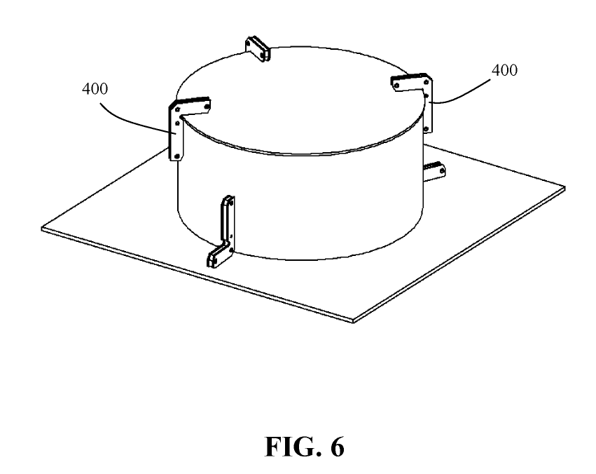

FIG. 7 shows another sample usage by the magnetic holders disclosed in this application. A trapezoidal tank is formed by clamping four metal plates together. An Allen key is shown inserted to the hex hole of one fixed angle magnetic holder, allowing for prying action to remove the magnetic holders.

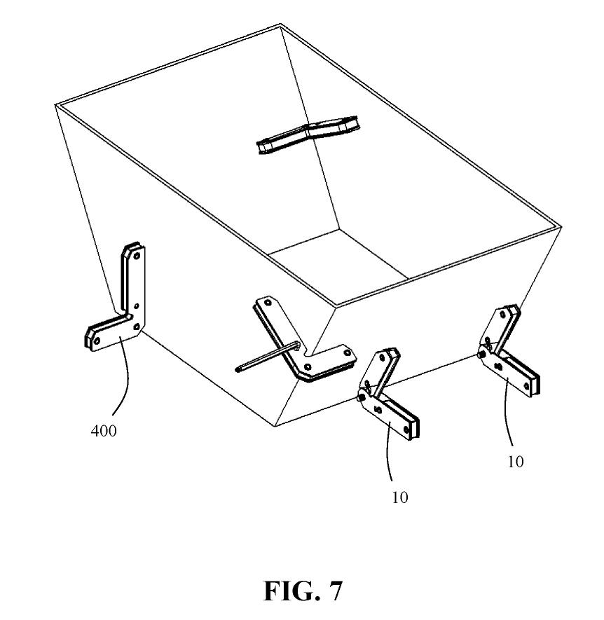

### DETAILED DESCRIPTION OF THE PREFERRED EMBODIMENT

As shown in the figures, a multi-angle magnetic holder 10 is made up of a first arm piece 100 and second arm piece 200.

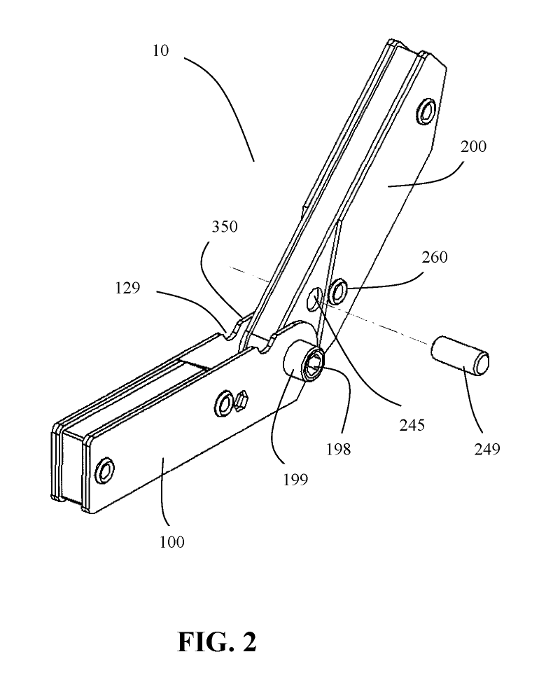

As shown in FIG. 2, first arm piece 100 has a first center magnetic block 101, which is tightly wrapped in between two opposite outside covers 190 and 191. Second arm piece 200 has a second center magnetic block 201, which is tightly wrapped in between two opposite outside covers 290 and 291.

First arm piece 100 and second arm piece 200, along with the outside covers, are hingeably connected at an end with a locking hinge 199, so that a desired angle can be made by pivoting at the hinge connection point, as measured from the edges of first arm piece 100 and second arm piece 200.

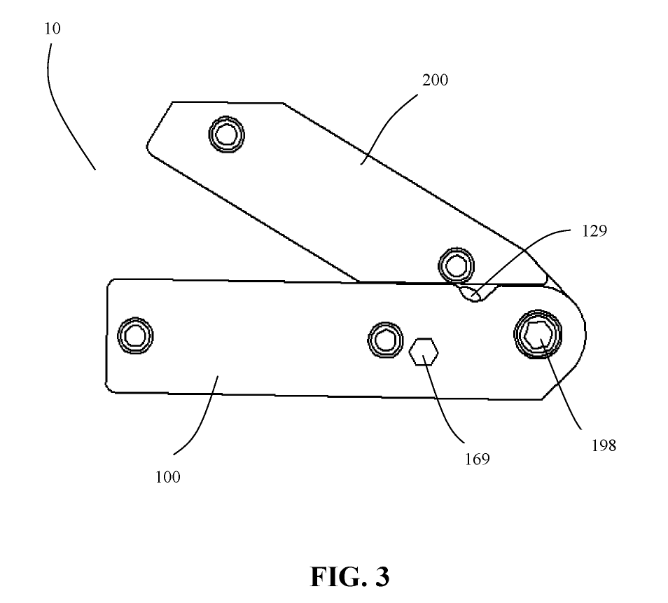

FIGS. 3-5 show formed angles of 30-degree, 45-degree and 90-degree, respectively.

The locking hinge 199 provides a six-sided Allen key hole with an internal (not shown) tightening mechanism 350 adjustable by an Allen key. The tightening mechanism 350 can be any commercially available screwing mechanism to tighten and set an angle between the first arm piece 100 and second arm piece 200 and is a known art that requires no further disclosure herein.

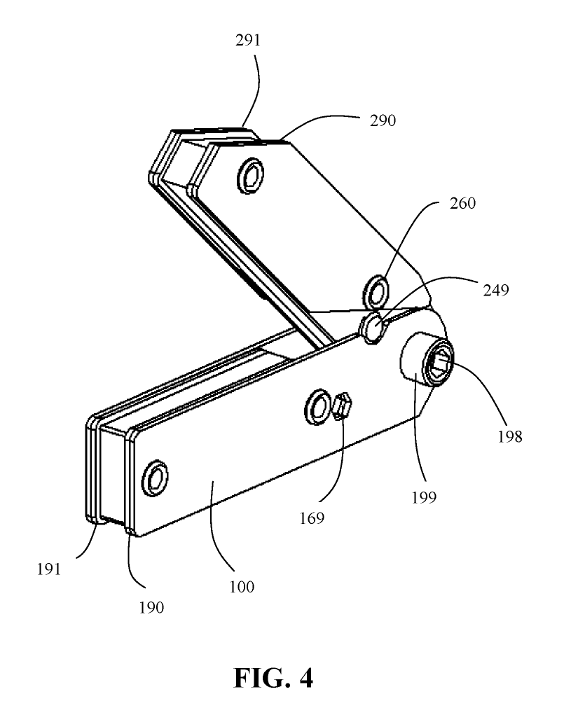

As shown in FIGS. 2 and 4, the two opposite covers 190/191 of the first arm piece 100 have a cave-in notch 129 in a location near the locking hinge 199. The second arm piece has a 45D hole 245 in a location near the locking hinge 199, so that a round pin 249 can be placed into the 45D hole 245 when the two arm pieces 100/200 are pivoting to close the angle between them, the two end tips of the round pin 249 will get wedged into the cave-in notch 129, forming a 45-degree angle between the first arm piece 100 and the second arm piece 200.

As shown in FIGS. 2 and 4, the second arm piece 200 has a protruding nut 260 so that when the two arm pieces 100/200 are pivoting to close the angle, the protruding nut 260 will rest on an edge of the one of the opposite covers 190/191 of the first arm piece 100, forming a 30-degree angle.

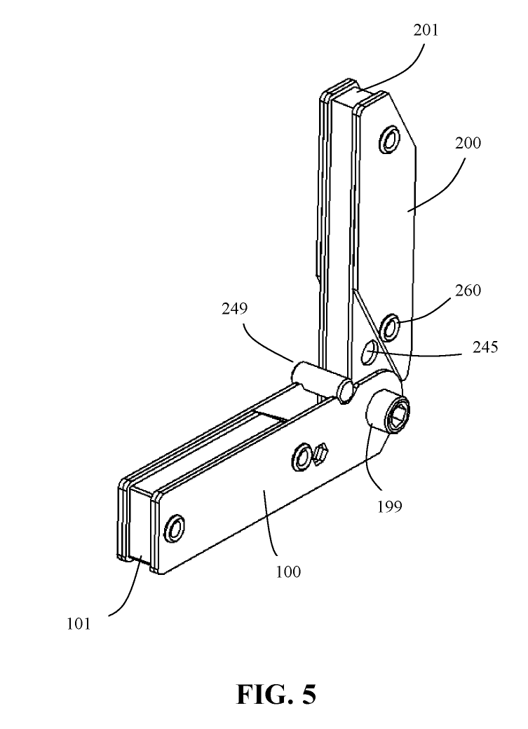

As shown in FIGS. 2 and 5, the round pin 249 can be placed on top of the cave-in notch 129, so that when the two arm pieces 100/200 are pivoting to close the angle between them, the second arm piece 200 will stop at the contact point of the round pin 249, resulting in a 90-degree angle between the two arm pieces 100/200.

A hex hole 169 is made on either the first arm piece 100 or the second arm piece 200, also through the two outside covers 190/191, or 290/291. The hex hole 169 permits an Allen key to be inserted through, or any small hard pin or similarly shaped object to be inserted through, providing a prodding force to pry the magnetic holder away from a work object being held or clamped onto.

The round pin 249 and the outside covers 190/191 and 290/291 are all made from magnetizable materials, such as iron or similar metals.

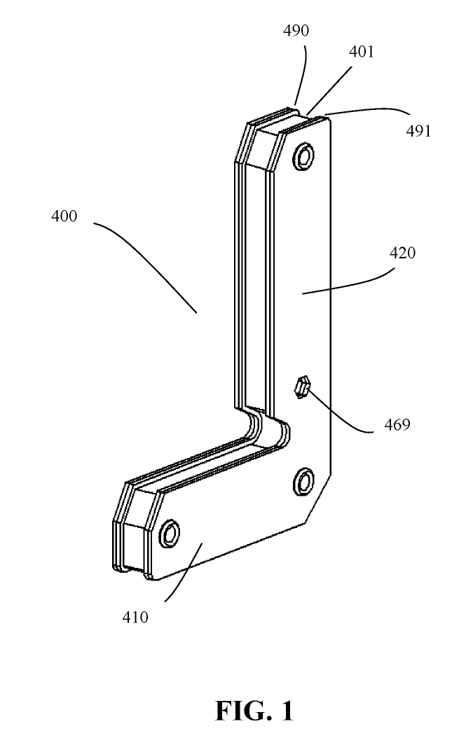

A variant version of the multi-angle magnetic clamping tool 400 is provided, as shown in FIG. 1, where there is a fixed angle between the first arm piece 410 and second arm piece 420. A set of opposite outside covers 490 and 491 tightly wrapped the two arm pieces 410/420 in place, forming a fix 90-degree angle.

A hex hole 469 is provided on one of the arm pieces, allowing for easy prying action to separate the magnetic holder 400 from a work object.

At outside corners of the two arm pieces 410/420, including the outside covers 491/492, some angles are made to specifically correspond to 30-degree, 45-degree and 60-degree bevel angles, as shown in FIG. 1, so that the magnetic holder 400 can be used to hold material in place using these outside preset angles without needing to take any measurement.

The outside covers are of suitable metal materials that can properly become magnetized to transfer the magnetic attribute exerted by the two magnetic blocks, allowing easy attachment to work pieces with similar magnetizable attributes.

1. A multi-angle magnetic holder, comprising:
a first arm piece having a first center magnetic block;
a first set of two opposite outside covers tightly wrapping the first center magnetic block between the covers;
a second arm piece having a second center magnetic block;
a second set of two opposite covers tightly wrapping the second center magnetic block between the covers; and
a locking hinge serving as rotatable connection between the first and second arm pieces where a tightening mechanism is provided to receive a hex key into a matching key hole for purpose of setting and adjusting angles formed between the first and second arm pieces
wherein the two opposite covers of the first arm piece further have a cave-in notch in a location near the locking hinge, and the second arm piece has a hole for 45-degree setting in a location near the locking hinge, whereby a round pin can be placed into the hole for 45-degree setting so that when the two arm pieces are pivoting to close the angle between them, two end tips of the round pin will get wedged into the cave-in notch, forming a 45-degree angle between the first arm piece and the second arm piece, and
wherein the second arm piece has a protruding nut so that when the two arm pieces are pivoting to close the angle between them, the protruding nut rest on an edge of the one of the opposite covers of the first arm piece, forming a 30-degree angle, and
wherein a round pin can be placed directly on top of the cave-in notch so that when the two arm pieces are pivoting to close the angle between them, the second arm piece stops at a contact point of the round pin, forming a 90-degree angle.

2. (canceled)

3. (canceled)

4. (canceled)

5. The multi-angle magnetic holder of claim 1, wherein a hex hole is formed on one of the two aim pieces to receive a match hex key for prying action.

6. (canceled)
